(19) United States
(12) Patent Application Publication
(10) Pub. No.: US 2014/0091936 A1
(43) Pub. Date: Apr. 3, 2014

(54) Occupancy Detection System

(71) Applicant: Brian O'Reilly, Glasgow (GB)

(72) Inventor: Brian O'Reilly, Glasgow (GB)

(73) Assignee: University of Strathclyde, Glasgow (GB)

(21) Appl. No.: 14/005,800

(22) PCT Filed: Mar. 14, 2012
(86) PCT No.: PCT/GB12/50562

§ 371 Date: Nov. 27, 2013

(30) Foreign Application Priority Data
Mar. 17, 2011 (GB) 1104483.1

(51) Int. Cl. G08B 21/22

(52) U.S. Cl. CPC G08B 21/22
USPC 340/669

(57) ABSTRACT

A presence determination system comprising at least one motion sensor for detecting movement in a sensing area. The system is adapted to determine a plurality of properties associated with at least one movement detected by the at least one sensor preceding a period where no motion is detected by the at least one sensor. The plurality of properties of the movement(s) detected before the period where no movement is detected are compared with a profile in order to determine whether or not the sensing area is unoccupied. The profile may be representative of movement properties indicative of exiting a room.

The present invention relates to a system and method for detecting occupancy and/or movement and an associated method.

### BACKGROUND

Devices that rely on occupancy detection are used in a variety of applications, such as turning on or off lights or other electrical equipment depending on whether or not the room is determined to be occupied.

Such devices typically use a passive infra-red (PIR) sensor. The PIR sensor is operable to detect changes in infra-red signatures, for example due to heat given out by people within the sensing area of the PIR sensor. Such changes in the detected infra-red signal are interpreted as movements. Known occupancy detection systems are generally arranged to turn on lights or other electrical devices when a movement is detected and/or turn off lights or other electrical devices when no movement has been detected for a period of time. In this way, power consumption by the lighting system and/or electrical devices is reduced by powering down the lights and/or electrical devices when the area is unoccupied.

A problem with existing occupancy detection systems is false determinations that the sensing area is unoccupied when the occupant is still within the sensing area but making little or no movement. Typically, this problem is addressed by providing a timing circuit such that the system is only powered down after no movement has been detected for a certain timeout period.

In order to address energy usage concerns, systems have been provided that use adaptive timeout periods, to ensure that the lights or electrical appliances are not switched on for longer than necessary but still minimise false determinations of an unoccupied sensing area and the resulting deactivation of lights or electrical equipment when the area is still occupied.

The object of the present invention is to provide an improved device that solves or minimises at least one problem with the prior art.

### SUMMARY OF INVENTION

According to a first aspect of the invention is a presence determination system comprising at least one motion sensor for detecting movement in a sensing area; the system being adapted to determine a plurality of properties associated with at least one movement detected by the at least one sensor and compare a plurality of movement properties preceding a period where no motion is detected by the at least one sensor with a profile in order to determine whether or not the sensing area is unoccupied.

The profile may be representative of movement properties indicative of exiting a room.

The presence detection system may be configured to distinguish between the sensing area being unoccupied and the sensing area being occupied by a stationary occupant based on the comparison of the plurality of properties associated with at least one movement detected by the at least one sensor preceding a period where no motion is detected by the at least one sensor with the profile representative of movement properties indicative of exiting a room.

The system may comprise a processor for controlling the system and/or processing movement data from the sensor. The system may comprise a control module, the control module comprising the processor. The system may comprise at least one power controller for controlling power to at least one electrical device. At least one power controller and/or sensor may be remote from the control module. The system may comprise communications means for providing communications between the control module and the one or more power controllers and/or the at least one sensor. The communications means may be wireless communications means.

The system may be adapted to control the electrical supply to a device based on the comparison of the properties of the movement with the criteria. Control of the electrical device may comprise interrupting power to the electrical device.

The system may comprise a timer. The system may be configured to reduce the timer in the absence of movement detected by the sensor. The timer may be configured to time or count down a timeout period. The timeout period may be a period during which no movement is detected before the system interrupts power to an electrical device. The timer may be resetable if movement is detected by the sensor, such that the timer restarts countdown of the timeout period. The system may be configured to deactivate at least one electrical appliance if the time since the last movement detected equals or exceeds the timeout period.

The system may comprise timeout period adjustment means for permitting a user to adjust the timeout period. The system may be configured to automatically adjust the timeout period, preferably to extend the timeout period. The system may be configured such that the timeout period is not automatically adjustable below the timeout period set by the user.

The profile may be adaptable and/or configured and/or configurable for at least one particular room or sensing area. The profile may be adaptable or at least partially learned based on one or more properties associated with at least one previous movement detected by the at least one sensor, which may be properties associated with a movement in a room or location where the system is located.

The profile may comprise one or more criteria. Each criterion may be associated with a particular action performed by an occupant. The profile may comprise a plurality of criteria associated with a plurality of actions. The processor may be adapted to determine an action performed by comparing properties of the signal with the criteria. The profile may be indicative of a pattern in the sensor signal, such as a pattern associated with, or indicative of, an action, such as exiting of the sensing area.

The actions may comprise at least one subject leaving a room and/or entering a room. The actions may comprise at least one subject being relatively motionless whilst remaining in a room, for example if the subject is sleeping and/or simply remaining inactive. The actions may comprise at least one subject standing up. The actions may comprise at least one subject exiting a room at a distance from the sensor.

The system may be adapted to extend and/or reduce the timeout period by a variable amount. The extension or reduction of that the timeout period may be dependent on a plurality of criteria, which may comprise a combination of criteria. The criteria may comprise at least two and preferably all of an amplitude criterion and/or a period criterion and/or a frequency criterion. The criteria may comprise at least two periods, which may comprise a time between movements and/or duration of individual or predefined groups of movements. If the time out were only adaptive to a single parameter, for example frequency, then the system may not be as effective in differentiating between unoccupied and occupied rooms in situations where the frequency of movement is low, which may be commonplace, for example, if a user is sitting still watching television.

The system may be configured to analyse a signal indicative of movement generated by the sensor. The system may be configured to analyse signals indicative of a series of movements preceding a period where no motion is detected by the at least one sensor. A period where no motion is detected may be a period where the output from the sensor is below a threshold. By analysing signals associated with a series of movements, it may be possible to determine common features indicative of an exit from the sensing area that are independent of sensor position. The analysis of the signal indicative of movement may comprise comparison of properties of at least one detected movement with criteria of the profile. Criteria of the profile may be associated with a timeout adjustment period. The processor may be arranged to extend and/or reduce the timeout period depending on the results of the comparison of the movement properties with the criteria of the profile.

The system may be configured to apply a greater weight to properties associated with at least one more recent movement relative to properties of at least one less recent movement.

The system may be adapted to compare the period between detected movements with a movement period threshold and to treat any detected movements having a period between the movements lower than the movement period threshold as a single movement. The movement period threshold may be a dynamic threshold. The movement period threshold may be adjustable. The movement period threshold may be dependent on the timeout period set by the user.

The system may be adapted to determine a frequency of motion. The profile may comprise at least one frequency criterion, which may comprise a frequency threshold, which may be a dynamic threshold. The frequency may depend on a period between a specified number of movements detected by the sensor. The frequency may be related to the inverse of the period between movements. The frequency may be equal to (n−1)/(the period between the last n movements).

The frequency threshold may be variable. The frequency threshold may be user adjustable. The frequency threshold may be dependent upon the timeout period set by the user using the timeout period adjustment means.

The system may adapted to compare the determined frequency of motion with the frequency threshold. Low frequency motions before a period of no detected motion may be indicative of someone sleeping or remaining inactive in a room. Therefore, such situations may require further analysis in order to minimise false exit readings. As such, the system may be adapted to analyse further movement properties, such as period and/or amplitude if the system determines that the detected movement frequency is below the frequency threshold. If the frequency is below the frequency threshold, the system may be configured to adjust the timeout by a variable amount that depends on whether or not the amplitude is above an amplitude threshold and/or a period is above a period threshold.

The system may be adapted to determine a period of motion. The period of motion may be representative of the duration of movements. The profile may comprise at least one period criterion, which may comprise a period threshold, which may be a dynamic threshold. The system may be adapted to compare the determined period of motion with the period criterion.

The system may be adapted to determine an amplitude from the signal. The amplitude may be a magnitude of a passive infra-red value derived from the sensor. The magnitude of the PIR signal may be proportional to a range of movement. For example hand movements may have a smaller amplitude than a whole body movement.

The profile may comprise at least one amplitude criterion, which may comprise an amplitude threshold, which may be a dynamic threshold.

The processor may be configured to determine the amplitude from a plurality of sensor values associated with a plurality of movements. The processor may be adapted to apply statistical analysis and/or determine a statistical value determined from sensor values associated with a plurality of movements. The processor may be adapted to determine an aggregated amplitude derived from the plurality of movements. The statistical or aggregated amplitude may be determined from amplitude values associated with a specified number of most recent movements. The system may be adapted to store sensor output values derived from a number of most recent movements. The processor may be configured to update the statistical and/or aggregate amplitude upon detection of a new movement by the sensor or at specified numbers of detected movements or periodically.

By using a statistical or aggregate value, that may comprise historical movement data, rather than simply using the most recently detected amplitude value, then a degree of learning may be imparted to the occupancy determination process and occupancy detection accuracy may be increased. By using an amplitude determined from a number of sensor values and not individual sensor values, discrepancies due to variations in the distance between the movements and the sensor can be reduced. For example, movements made further away from the sensor generally have a smaller PIR amplitude than corresponding movements made closer to the sensor. If individual detected amplitudes were compared with a threshold, erroneous exit signals may be generated by motions close to the sensor. The statistical or aggregate value is less affected by very high or very low amplitude movements, such as those created by movements very close to or very far away from the sensor, such that they may not disproportionately affect the exit signal determination.

The system may be adapted to determine if the number of movements for which sensor data is available is less that the number of movements required to determine the medium amplitude and if so, determine the medium amplitude based on the number of movements for which sensor data is available and not a predetermined number.

The system may be configured to compare the statistical and/or aggregate amplitude with amplitude criteria, which may comprise a comparison with a threshold value, such as a dynamic threshold, or comprise an amplitude ratio.

The profile may be embodied in a look-up table. The profile may associate combinations of results of criteria comparisons with specified timeout extensions. The profile may define a pattern in a series of movements that is indicative of an exit from the sensing area. The system may be configured to compare the property values associated with at least one movement with the criteria property values of the profile and extend the timeout period by an extension period associated with the determined combination of property values.

According to a second aspect of the invention is a presence determination method comprising detecting movement in a sensing area using a sensor, determining a plurality of properties of the movement detected by the sensor preceding a period where no motion is detected by the at least one sensor and comparing the plurality of properties with a profile in order to determine whether or not the sensing area is unoccupied.

The profile may be representative of movement properties indicative of exiting a room and the method may comprise, after a period where no motion is detected by the at least one sensor, determining if the plurality of movement properties detected by the sensor preceding the period where no motion is detected are indicative of exiting a room.

The profile may comprise one or more criteria. Each criterion may be associated with a particular action. The profile may comprise a plurality of criteria associated with a plurality of actions. The method may comprise determining an action performed by comparing properties of the signal with the criteria.

The actions may comprise at least one subject leaving a room. The actions may comprise at least one subject being relatively motionless whilst remaining in a room, for example if the subject is sleeping and/or simply remaining inactive. The actions may comprise at least one subject standing up. The actions may comprise at least one subject exiting a room at a distance from a sensor.

The method may comprise analysing a signal indicative of movement generated by the sensor. The analysis of the signal indicative of movement may comprise comparison of properties of at least one detected movement with criteria of the profile. The method may comprise extending and/or reducing the timeout period depending on the results of the comparison of the movement properties with the criteria of the profile.

The method may comprise extending and/or reducing the timeout period by a variable amount. The extension or reduction of that the timeout period may be dependent on the plurality of criteria, which may comprise a combination of criteria. The criteria may comprise at least two and preferably all of an amplitude criterion and/or a period criterion and/or a frequency criterion.

The method may comprise comparing a period between detected movements with a movement period threshold and to treat any detected movements having a period between the movements lower than the movement period threshold as a single movement.

The method may comprise determining a frequency of motion. The profile may comprise at least one frequency criterion, which may comprise a frequency threshold. The frequency may depend on a period between a specified number of movements detected by the sensor. The frequency may be equal to (n−1)/(the period between the last n movements).

The frequency threshold may be variable. The frequency threshold may be user adjustable. The frequency threshold may be dependent upon the timeout period set by the user using the timeout period adjustment means.

The method may comprise comparing the determined frequency of motion with the frequency threshold. The method may comprise analysing further movement properties, such as period and/or amplitude if it is determined that the detected movement frequency is below the frequency threshold. If the frequency is below the frequency threshold, the timeout may be adjusted by a variable amount that depends on whether or not the amplitude is above an amplitude threshold and/or a period is above a period threshold.

The method may comprise determining a period of motion. The period of motion may be representative of the duration of movements. The profile may comprise at least one period criterion, which may comprise a period threshold. The method may comprise comparing the determined period of motion with the period threshold.

The method may comprise determining an amplitude from the signal. The amplitude may be a magnitude of a passive infra-red value derived from the sensor. The magnitude of the PIR value may be proportional to a range of movement.

The profile may comprise at least one amplitude criterion, which may comprise an amplitude threshold.

The method may comprise determining the amplitude from a plurality of sensor values associated with a plurality of movements. The method may comprise determining an aggregated amplitude derived from the plurality of movements. The aggregated amplitude may be a medium amplitude. The medium amplitude may be determined from amplitude values associated with a specified number of most recent movements. For example, the medium amplitude may be the medium amplitude of the last 10 detected movements. The method may comprise storing sensor output values derived from a number of most recent movements. The method may comprise ordering the stored sensor output values based on amplitude and determining the medium amplitude value of the ordered list. The method may comprise updating the medium amplitude responsive to detection of a new movement by the sensor and/or at specified numbers of detected movements and/or periodically.

The method may comprise determining if the number of movements for which sensor data is available is less that the number required to determine the medium amplitude and if so, determining the medium amplitude based on the number of movements for which sensor data is available and not a predetermined number.

The method may comprise comparing the medium amplitude with the amplitude threshold.

The profile may be embodied in a look-up table. The profile may associate combinations of criteria comparison results with specified timeout extensions. The method may comprise comparing the property values associated with at least one detected movement with the criteria property values of the profile and extending the timeout period by an extension period associated with the determined combination of property values.

It will be appreciated that features analogous to the preferred or optional features described in relation to any of the aspects of invention may be applicable to other aspects. Method features analogous to apparatus features described in respect of any aspect may also be provided in respect of any other aspect and vice versa.

### BRIEF DESCRIPTION OF THE DRAWINGS

Various aspects of the invention will now be described by way of example only and with reference to the accompanying drawings of which:

FIG. 1 is an overview of a presence detection system according to an embodiment of the present invention;

FIG. 2 is a schematic of a presence detection system according to an embodiment of the present invention;

FIG. 3 is a flow chart illustrating a movement property value determination process according to an embodiment of the invention; and

FIG. 4 is a flowchart illustrating a movement analysis process according to an embodiment of the invention.

### DETAILED DESCRIPTION OF THE DRAWINGS

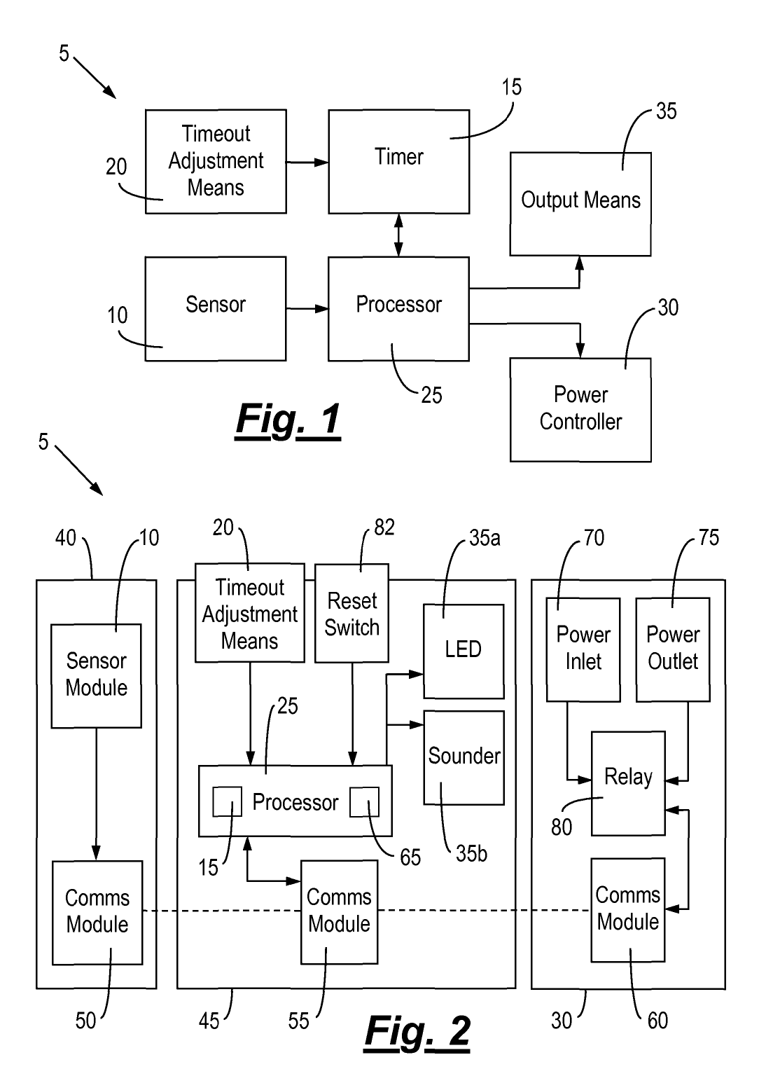

FIG. 1 shows a schematic of a presence detector system 5 comprising a passive infra-red (PIR) sensor 10, a timer 15, timeout period adjustment means 20, a processor 25, a power controller 30 and an output device 35.

In an optional embodiment as shown in FIG. 2, the system 5 is modular. In this case, the PIR sensor 10 is provided in a sensor module 40 and the timer 15, processor 25 and any output devices, such as an LED 35a and/or a sounder 35b, are provided in a control module 45. The power controller 30 and the sensor module 40 are remote from the control module 45 and linked by a wireless communications system 50, 55, 60. Wireless signals sent by the wireless communications system 50, 55, 60 contain an identifier associated with a specific system 5. In this way, the power controller 30 and sensor 10 only communicate with a control module 45 with which they are associated. The control module 45 is capable of controlling all the power controllers 30 in the range by sending commands of ‘ON’, ‘OFF’ or ‘ALL OFF’, such that power controllers 30 may be operated individually, in groups or as a whole by the control module 45. The raw data in the signal is encoded using coding means known in the art, such as on-off keying (OOK).

It will be appreciated that, in other embodiments, at least one PIR sensor 10 and/or power controller 30 may be integral with and/or in wired communication with the control unit 45.

The PIR sensor 10 is a device for measuring infrared radiation that is emitted by objects, such as people, within a sensing area and examples of PIR sensors 10 are widely known in the art. The PIR sensor 10 is operable to detect changes in received infra-red radiation, which is equated to movements of people in the sensing area. By mounting the PIR sensor 10 within a room, the sensor 10 is operable to detect movements within the room.

Signals representative of detected movements are fed from the PIR sensor 10 to the control unit 45, which are stored in a memory 65 and processed by the processor 25.

The power controller 30 is connected to an electrical supply via a power inlet 70 and at least one electrical device is connected to the power controller 30 via a power outlet 75. The power controller 30 is operable to interrupt and restore power to the connected electrical devices using a relay 80 according to signals received from the control module 45. Examples of electrical devices that may be connected include lights, air conditioners, HVAC systems and the like.

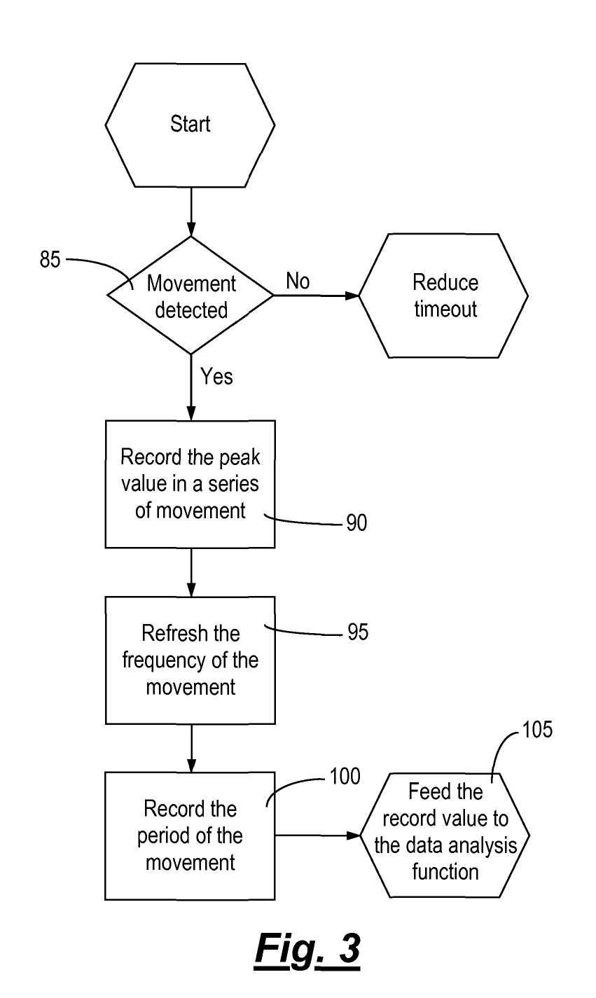

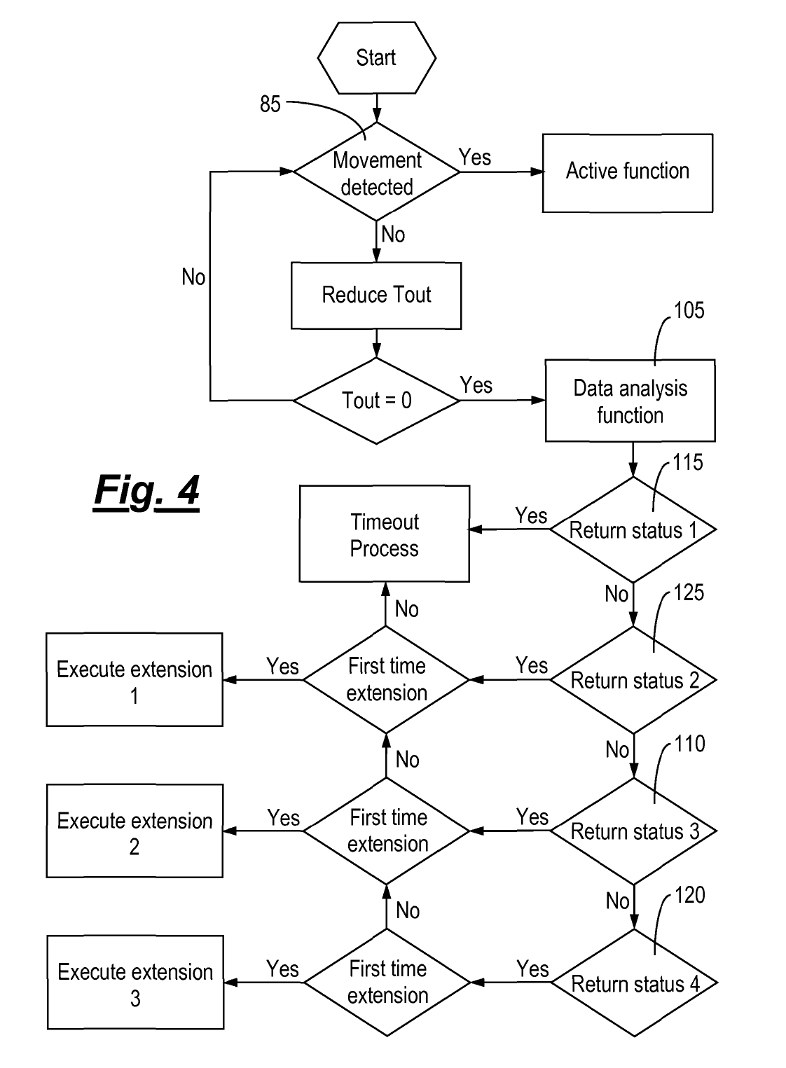

The timer 15 is operable to countdown a timeout period between detected movements, as shown in FIGS. 3 and 4. The timeout adjustment means 20 permit a user to manually adjust the timeout period.

If a movement is detected 85 by the PIR sensor 10, then the timer 15 is reset to the timeout period. In addition, the detected movement is analysed in order to determine values of properties related to the movement, such as a peak PIR value or amplitude 90, a movement period 95 and a movement frequency 100, as shown in FIG. 3.

If the timeout period reduces to zero, then the processor 25 is configured to determine if a timeout period should be extended based on the results of a data analysis function 105 using the determined property values associated with movements detected before the period of no detected movement.

If the timeout period is not to be extended, then the output device 35 is operable to output an audible and/or visual warning. After a further period, the processor 25 signals the power controller 30 to interrupt power to the connected electrical device. If a reset condition is received, such as manual resetting of the system, for example by operation of a switch or button 82, or a reset being triggered by a detected movement, then the processor 25 is operable to signal the power controller 30 to resume power supply to the electrical device(s).

The data analysis function 105, as shown in FIG. 4, comprises determining values of properties associated with one or more detected movements preceding the period where no motion is detected and comparing the determined properties with property criteria in a profile. A status indicator is then returned depending on which criteria of the profile are matched by the values of properties extracted from the detected movements. The profile contains timeout extensions associated with combinations of property criteria. Timeout extensions may be determined by matching the determined combination of property values with the associated criteria and matching the results with the criteria result combinations in the profile. An associated status indicator is then returned which is indicative of a timeout extension to be applied.

The properties of the movement comprise frequency, period and amplitude and the profile comprises a frequency criterion, an amplitude criterion and a period criterion.

The processor is configured to determine if a gap between detected movements is below a movement threshold, for example, three seconds. If the gap between movements is below the movement threshold then the movements are treated as a single movement. Multiple detected movements may be treated as a single movement, with a new movement only being determined if a gap greater than the movement threshold elapses between consecutive detected movements.

The processor is configured to determine properties of the movements from the signals received from the sensor. In particular, the processor is operable to derive indications of amplitude, frequency and period associated with movements from the PIR value obtained from the sensor.

The amplitude is related to the magnitude of the PIR value derived from the sensor, which is indicative of the range of movement. For example, hand movements will generally have a smaller amplitude than whole body movements.

The processor is operable to determine an aggregated amplitude, such as a medium value amplitude. In this case, rather than simply comparing an amplitude associated with an individual movement with a threshold, the processor is configured to determine a medium value amplitude based on amplitudes associated with a number of the most recent movements, for example, the last ten movements. When a fresh PIR value from the sensor is received by the processor, it is stored in the memory. The most recent ten movements are ordered by amplitude and the medium amplitude value calculated. The medium amplitude value is refreshed at periodic intervals.

The medium amplitude value is compared to an amplitude threshold in order to determine if the amplitude is low or high, depending on whether it is above or below the threshold. A low or high amplitude may be matched against amplitude criteria in the profile in order to determine an associated timeout extension.

By using an aggregated amplitude that depends on the amplitude of a plurality of movements, the system is less sensitive to false exit readings due to variations in the distance of the movement from the sensor, as movements further from the sensor will have smaller PIR amplitudes than corresponding movements made closer to the sensor. In contrast, if individual amplitude readings were simply compared to a threshold, a movement close to the sensor could appear disproportionately large compared to movements further away from the sensor, leading to false exit readings. By using a medium amplitude technique, a few large amplitude readings due to movements close to the sensor do not have a disproportionate effect on the occupancy determination process.

The processor is operable to determine a frequency (f), which is defined as:

f=(n−1)/(period between the last n movements)

For example, the frequency can be determined using the relation f=2/(period between the last 3 movements).

The determined frequency is compared to a dynamic frequency threshold that is varied depending on the timeout period set by a user using the timeout adjustment means. By using a dynamic frequency threshold, a determination of low frequency becomes more relevant to the scenario where someone is sleeping in a room.

The processor is configured to determine a movement period, which is analogous to the length of time a movement is detected for. A long period may be indicative of a person walking around a room or someone leaving the room.

The period is compared to a period threshold, the result of this comparison being useable to determine whether or not to extend the timeout period.

Indicators for amplitude, frequency and period are set to be “1” or “high” if the determined aggregated amplitude, frequency and period are above the respective thresholds and “0” or “low” if they are found to be below the respective thresholds. A profile in which variable timeout period extensions are assigned to various criteria in the form of amplitude, frequency and period indicator combinations, is stored in the memory. The processor 25 is then operable to look up a timeout period extension associated with the indicators of amplitude, frequency and period determined from the PIR values from the profile.

If the PIR sensor 10 detects a period of high frequency movement followed by a sudden lack of movement, then this is strongly indicative of an exit signal. However, a higher probability of exit detection errors arises in the case where there are periods of low frequency movement before an extended period of no movement. In order to determine if a period of no movement is the result of a genuine exit, or a user merely sleeping or remaining relatively stationary, then further data analysis is carried out if the frequency of motion is determined to be low before a period of no detected motion.

In the case that the frequency of motion is determined to be below the frequency threshold, then the timeout extensions are determined using a profile. According to the profile, if the amplitude is determined to be high but the period and frequency low, then this may be indicative of small movements during sleep. In this case, if the timeout period has not previously been extended since the last reset, a status value of “3” is returned 110, and the threshold is extended by a small amount. In each case where the timeout period is extended, it is extended by a period that is dependent on, or a function of, the timeout period set by the user (Tout) using the timeout period adjustment means. If the amplitude and period are determined to be high but the frequency low, then this may be indicative of a person standing up and exiting the room. In this case, if the timeout period has not previously been extended since the last reset, a status value of “1” is returned 115, and the timeout period is not extended. If each of the amplitude, period and frequency are low, then this may be indicative of someone taking a nap. In this case, if the timeout period has not previously been extended since the last reset, a status value of “4” is returned 120, and the timeout is extended by a relatively large amount. If the period is determined to be high but the amplitude and frequency is determined to be low, then this may be indicative of an exit at a large distance from the sensor or a light nap. In this case, if the timeout period has not previously been extended since the last reset, a status value of “2” is returned 125, and the timeout period is extended by a medium amount. In the logic implemented by the profile, a large amplitude value following a long period of silence is an indicator of an exit signal. Similarly, a long continuous movement implies a higher possibility of an exit.

For example, if a subject sits on the sofa watching a television then falls asleep, then a few small movements with low frequency, low amplitude and short period occur before a period of no movement. Thus the processor will return a status of 4 based on the profile and extend the timeout period for a relatively long time.

In another example, if a subject sits on the sofa and keeps relatively still with few movements then gets up and leaves the room, the frequency would be low, but the amplitude would be quite high. Furthermore, the exiting would result in a long period movement. Therefore, the processor returns a status 1, which indicates an exit signal and the timeout is not extended.

In this way, the system is able to more accurately discriminate between situations where a user is present but inactive and situations where the user has left the room.

The above system is configured to learn movement behaviour for a room e.g. period, amplitude and frequency of the majority of movements and use this data to construct an exit signature for the room i.e. forecast the signal characteristics of someone leaving a room. After a period of no movement it will analyse the last movement assign a probability of exit if it is analogous to an exit and adjust the timeout accordingly.

Although embodiments of the present invention have been described in the preceding paragraphs with reference to various examples, it should be appreciated that modifications to the examples given can be made without departing from the scope of the invention.

For example, although the system is described as being modular, the sensor unit and/or the control unit and/or the power controller may be integrated. In this case, it will be appreciated that a control module 45 of one system 5 may be capable of communicating and/or controlling a control module 45 and/or a sensor module 40 and/or a power controller 30 of another system 5. Although only one sensor module 40 and one power controller 30 are shown in FIG. 2, it will be appreciated that the control module 45 can be in communication with more than one sensor module 40 and/or power controller 30. Although wireless communications have been described, it will be appreciated that communication could be made via wired connections.

Although examples of properties or parameters including amplitude, frequency and period have been advantageously described, it will be appreciated that the system may not operate using all of these properties, or alternative and/or additional properties may be used.

Although a PIR sensor has been advantageously described, it will be appreciated that other sensors may be used such as sonic, magnetic or optical sensors.

1. A presence determination system comprising:
at least one motion sensor for detecting movement in a sensing area; and
a processor to process movement data from the sensor and determine a plurality of properties associated with at least one movement preceding a period where no motion is detected by the at least one sensor;
wherein the processor compares the plurality of properties with corresponding property criteria in a profile and returns a status indicator which is indicative of whether or not the sensing area is unoccupied dependent on the comparison.

2. A presence detection system according to claim 1, wherein the profile is representative of movement properties indicative of exiting a room.

3. A presence detection system according to claim 2, wherein the presence detection system is configured to distinguish between the sensing area being unoccupied and the sensing area being occupied by a stationary occupant based on the comparison of the movement properties detected by the at least one sensor preceding a period where no motion is detected with the profile representative of movement properties indicative of exiting a room.

4. A presence detection system according to claim 1, wherein the system is configured to analyse signals from the at least one motion sensor representative of a series of movements preceding a period where no motion is detected by the at least one sensor and determine whether or not the sensing area is unoccupied accordingly.

5. A presence detection system according to claim 1, wherein the profile is adaptable for a specific room and/or sensing area.

6. A presence detection system according to claim 1, wherein the profile is adaptable and/or at least partially learned based on one or more properties associated with at least one previous movement detected by the at least one sensor.

7. A presence detection system according to claim 1, wherein the profile comprises one or more criteria and each criterion is associated with an action performed by an occupant.

8. A presence detection system according to claim 1, wherein the system is configured to extend a timeout period by a variable amount.

9. A presence detection system according to claim 1, wherein the movement properties comprise at least two of an amplitude of motion, a period of motion and a frequency of motion.

10. A presence detection system according to claim 9, wherein the system is configured to apply a greater weight to properties associated with at least one more recent movement relative to the properties of at least one less recent movement when determining whether or not the sensing area is unoccupied.

11. A presence detection system according to claim 1, wherein the system is adapted to compare the period between detected movements with a dynamic movement period threshold and to treat any detected movements having a period between the movements lower than the movement period threshold as a single movement.

12. A presence detection system according to claim 1, wherein the system is adapted to determine at least one frequency of motion and the profile comprises at least one frequency criterion, the system being adapted to compare the determined frequency of motion with the frequency criterion or criteria in order to determine whether or not the sensing area is unoccupied.

13. A presence detection system according to claim 12, wherein the system is adapted to analyse further movement properties if the system determines the detected movement frequency is below a frequency threshold.

14. A presence detection system according to claim 12, wherein the frequency criteria or criterion is dependent on a time-out period set by the user.

15. A presence detection system according to claim 1, wherein the system is adapted to determine at least one amplitude and/or period of motion and the profile comprises at least one amplitude and/or period criterion, the system being adapted to compare the determined amplitude and/or period of motion with the amplitude and/or period criterion or criteria in order to determine whether or not the sensing area is unoccupied.

16. A presence detection system according to claim 15, wherein the system is adapted to analyse an amplitude and/or period of movement if the system determines that the detected movement frequency is below a frequency threshold.

17. A presence detection system according to claim 15, wherein the system is configured to determine a statistical and/or aggregate amplitude based on a plurality of sensor values associated with a plurality of movements.

18. A presence detection system according to claim 17, wherein the system is configured to update the statistical and/or aggregate amplitude upon detection of a new movement by the sensor and/or at specified numbers of detected movements and/or periodically.

19. A presence detection system according to claim 12, wherein the profile associates combinations of results of criteria comparisons with specified timeout extensions.

20. A presence determination method comprising detecting movement in a sensing area using a sensor, determining a plurality of properties of the movement detected by the sensor preceding a period where no motion is detected by the at least one sensor and comparing the plurality of properties with corresponding property criteria in a profile to determine whether or not the sensing area is unoccupied, wherein the profile is representative of movement properties indicative of exiting the sensing area and wherein the method comprises, after a period where no motion is detected by the at least one sensor, determining if the plurality of movement properties detected by the sensor preceding the period where no motion is detected are indicative of exiting a room based on the comparison.

21. (canceled)
